(19) United States
(12) Patent Application Publication
(10) Pub. No.: US 2024/0408819 A1
(43) Pub. Date: Dec. 12, 2024

(54) POWDER COMPACTION ASSEMBLY, POWDER LAYING MECHANISM AND ADDITIVE MANUFACTURING EQUIPMENT

(71) Applicant: HON HAI PRECISION INDUSTRY CO., LTD., New Taipei (TW)

(72) Inventor: CHING-JU KUO, New Taipei (TW)

(21) Appl. No.: 18/651,360

(22) Filed: Apr. 30, 2024

(30) Foreign Application Priority Data
Jun. 7, 2023 (CN) 202321453377.3

(51) Int. Cl. B29C 64/218; B22F 12/63; B22F 12/67; B29C 64/153; B29C 64/214; B29C 64/321; B33Y 30/00

(52) U.S. Cl. CPC B29C 64/218; B22F 12/63; B22F 12/67; B29C 64/153; B29C 64/214; B29C 64/321; B33Y 30/00

(57) ABSTRACT

This disclosure provides a powder compaction assembly, a powder laying mechanism, and an additive manufacturing equipment. The powder compaction assembly includes a mounting frame, a powder compaction roller, a scraper, and a rotary member. The mounting frame is rotatably disposed in the mounting frame. The scraper is connected to the mounting frame along an adjusting direction removable. The adjusting direction and the molding surface are perpendicular or intersecting. The scraper is separable from the powder compaction roller. The rotary member is connected to the mounting frame rotationally and fitted with the scraper. The rotary member is configured to rotate relative to the mounting frame and drive the scraper to move along the adjusting direction, and adjust distance between the scraper and the molding surface along the adjusting direction.

### FIELD

The disclosure relates to a technical field of additive manufacturing, in particular to a powder compaction assembly, a powder laying mechanism, and an additive manufacturing equipment.

### BACKGROUND

In existing technology, some additive manufacturing equipment first lays powder layer on powder bed, and then processes the powder layer to form workpiece through layer processing and manufacturing. Quality of each powder layer affects the final molding quality of the workpiece directly. How to improve quality of laying powder is a pressing problem.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding portions throughout the several views.

FIG. 1 is a diagrammatic view of an additive manufacturing equipment according to an embodiment of the present disclosure.

FIG. 2 is a diagrammatic view of a powder compaction assembly of the additive manufacturing equipment shown in FIG. 1.

FIG. 3 is an explosive view of the powder compaction assembly shown in FIG. 2.

FIG. 4 is a cross-sectional view of the powder compaction assembly shown in FIG. 2 rotated a limit position.

FIG. 5 is a fantom view of the powder compaction assembly shown in FIG. 2 rotated another limit position.

FIG. 6 is a partial explosive view of the powder compaction assembly shown in FIG. 2.

FIG. 7 is a partial view of the powder compaction assembly shown in FIG. 2.

### DESCRIPTION OF MAIN COMPONENTS OR ELEMENTS

powder compaction assembly 100;
mounting frame 10;
first guide groove 11;
second guide groove 11a;
bottom surface 111;
first opening 112;
second opening 113;
first portion 12;
second portion 13;
powder compaction roller 20;
scraper 30;
rotary member 40;
sliding groove 41;
rotating plate 40a;
circular plate 40b;
first actuator 51;
second actuator 52;
bearing 53;
coupling block 54;
pinhole 55;
pin block 56;
guide part 61;
vertical segment 611;
horizontal segment 612;
moving arm 63;
round rod 63a;
powder spreading direction Y1;
adjusting direction Y2;
first tangent plane M1;
second tangent plane M2;
additive manufacturing equipment 200;
chassis 201;
print substrate 202;
drive element 203;
powder laying mechanism 204;
powder bin 205;
powder spreading roller 206;
molding surface 207.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

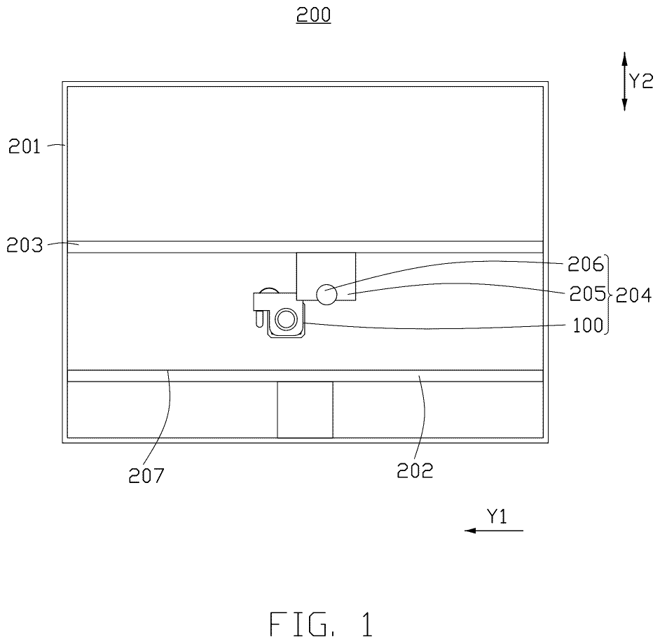

Referring to FIG. 1, in one embodiment, an additive manufacturing equipment 200 is provided. The additive manufacturing equipment 200 includes a chassis 201, a print substrate 202, a drive element 203, and a powder laying mechanism 204. The print substrate 202, the drive element 203, and the powder laying mechanism 204 are located in the chassis 201. The print substrate 202 defines a molding surface 207. The powder laying mechanism 204 is configured to lay down powder to the print substrate 202. The drive element 203 is configured to drive the powder laying mechanism 204 to move relative to the print substrate 202 along powder spreading direction Y1, the powder spreading direction Y1 is parallel to the molding surface 207.

In one embodiment, the drive element 203 is six-axis manipulator. In other embodiment, the drive element 203 maybe linear module or screw roller drive mechanisms.

In one embodiment, the print substrate 202 is fixed in the chassis 201. In other embodiment, the print substrate 202 can be movable arranged in the chassis 201.

Referring to FIG. 1, the powder laying mechanism 204 includes a powder bin 205, a powder spreading roller 206, and a powder compaction assembly 100. The powder bin 205 is configured to storage and export powder. An opening is defined on bottom of the powder bin 205. The powder spreading roller 206 is provided inside the powder bin 205 and disposed at the opening. When the powder roller 206 is rotated, the powder roller 206 drives the powder in the powder bin 205 and output the powder through the opening, and the powder drops onto the molding surface 207 of the printing substrate 202.

In other embodiment, the powder laying mechanism 204 can also be implemented by other structures.

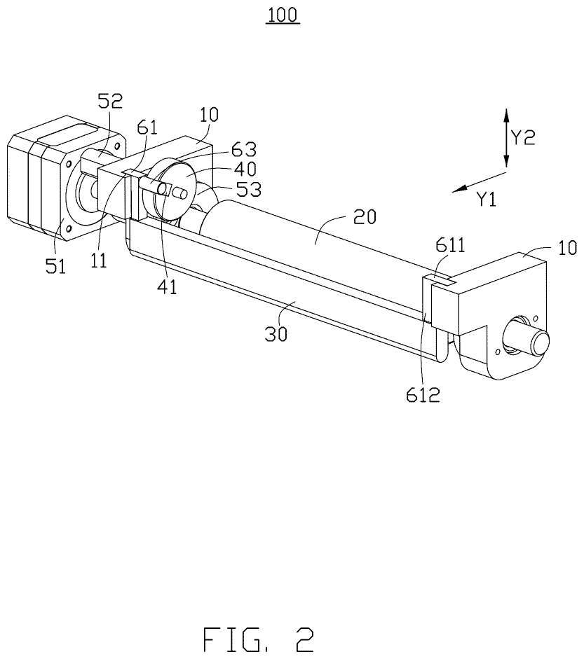

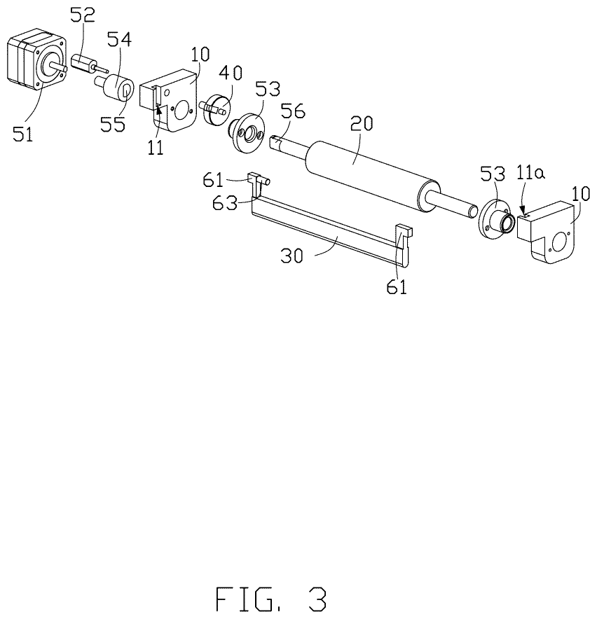

Referring to FIG. 2 and FIG. 3, the powder compaction assembly 100 includes one or more mounting frame 10, a powder compaction roller 20, a scraper 30, and a rotary member 40.

In one embodiment, the mounting frame 10 is connected to the powder bin 205, and the mounting frame is capable of moving with the powder bin 205. In other embodiment, the mounting frame 10 is connected to the drive element 203.

The powder compaction roller 20 is rotatably disposed in the mounting frame 10, and the powder compaction roller 20 is configured to compact the powder into a powder layer.

In one embodiment, the powder compaction assembly 100 further includes a first actuator 51. The first actuator 51 is connected to the mounting frame 10 or the powder bin 205. The first actuator 51 is configured to drive the powder compaction roller 20 to rotate along a spin axis, the spin axis is parallel to the forming surface 207. The rotating powder compaction roller 20 can improve compaction effect of the powder to increase density of powder layer.

In one embodiment, the fires drive 51 can be a motor.

The scraper 30 is moveably connected to the mounting frame 10 along adjusting direction Y2. The adjusting direction Y2 and the molding surface 207 are perpendicular or intersecting. The scraper 30 is separable from the powder compaction roller 20, and the direction of the powder compaction roller 20 pointing to scraper 30 is the powder spreading direction Y1.

In process of powder pressing, the powder layer is flattened by the scraper 30, and then compacted by the powder compaction roller 20. The scraper 30 can smooth the powder on the molding surface 207 to improve uniformity of the powder layer.

In one embodiment, the adjusting direction Y2 is perpendicular to the molding surface 207, to reduce space required for adjusting position of the scraper 30, reduce size of the powder compaction assembly 100 along the adjusting direction Y2.

The rotary member 40 is connected to the mounting frame 10 rotationally, and the rotary member 20 is fitted with the scraper 30. The rotary member 40 is configured to rotate relative to the mounting frame 10 and drive the scraper 30 to move along the adjusting direction Y2, and adjust distance between the scraper 30 and the molding surface 207 along the adjusting direction Y2. The rotary member 40 can drive the scraper 30 to move until distance between the scraper 30 and the molding surface 207 along the adjusting direction Y2 to meet the demand, and meet laying demand of the powder layer.

In one embodiment, when position of the scraper 30 along the adjustment direction Y2 is adjusted, position of a center of the rotary member 40 along the adjusting direction Y2 will not change, so that space occupied by the rotary member 40 is reduced, which is conducive to saving occupied space of the powder compaction assembly 100 and streamlining design space of the powder compaction assembly 100 greatly. Furthermore, by converting angular rotation of the rotary member 40 into linear motion of the scraper 30, accuracy of movement of the scraper 30 along the adjusting direction Y2 can be improved at a low cost.

Adjustment range of the scraper 30 along the adjusting direction Y2 can be adjusted by straight-line distance between the spin axis, and mating position of the scraper and the rotary member 40, and expand range of regulation of the scraper 30.

In one embodiment, the powder compaction assembly 100 further includes a second actuator 52, the second actuator 52 is connected to the mounting frame 10 or the powder bin 205. The second actuator 52 is configured to drive the rotary member 40 to rotate, and drive the scraper 30 move along the adjusting direction Y2.

In one embodiment, the second actuator 52 can be a motor.

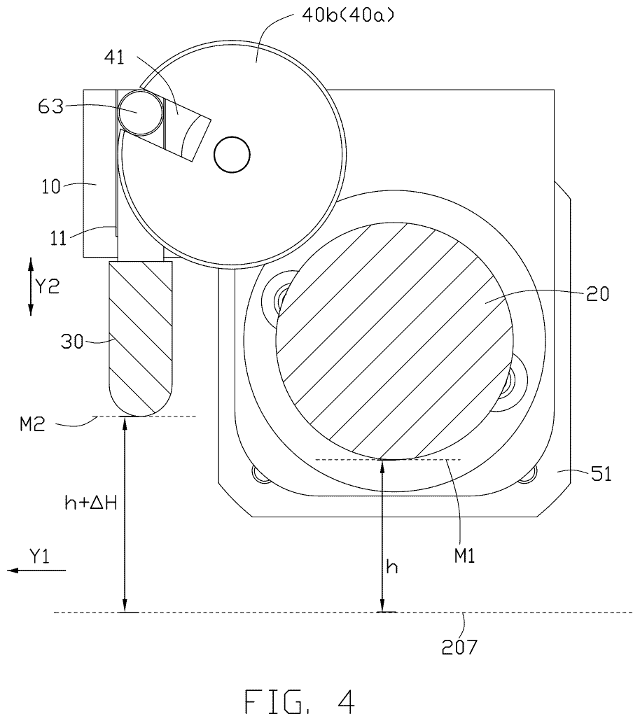

Referring to FIG. 4, the powder compaction assembly 100 defines a first tangent plane M1 and a second tangent plane M2. The first tangent plane M1 and the molding surface 207 are perpendicular. The is tangent to side of the powder compaction roller 20 close to the molding surface 207. The second tangent plane M2 and the molding surface 207 are perpendicular, and the second tangent plane M2 is overlap or in line contact with side of the scraper 30 close to the molding surface 207. Therefore, wear and tear of the scraper 30 are reduced when compacting the powder.

In one embodiment, a curved surface formed on a surface of the scraper 30 near the mounting frame 10 along the adjusting direction Y2. The curved surface is tangent to the second tangent plane M2. In other embodiment, the scraper 30 has a triangular cross-section with the tip of the triangle facing the molding surface 207. In other embodiment, a plane is formed on the surface of the scraper 30 near the mounting frame 10 along the adjusting direction Y2, and the plane coincides with the adjusting direction Y2.

Referring to FIG. 4, before the powder pressing assembly 100 operates, a target thickness h of the powder layer is preset, moving the mounting frame 10 until spacing between the first tangent plane M1 and the molding surface 207 equals to the target thickness h. Adjusting position of the scraper 30 by rotating the rotary member 40 along the adjustment direction Y2, until spacing between the second tangent plane M2 and the molding surface 207 equal to h+ΔH.

During movement of the powder laying mechanism 204, the powder is driven to move along the powder spreading direction Y1, and the scraper 30 first scrapes the powder layer to a thickness of h+ΔH. Uniformity of the powder layer is improved thereby, and surface of the powder layer has no defects such as cavities, but density of the powder is poor. Afterwards, the powder compaction roller 20 then exerts a force on the powder layer, and compacts the powder so that density of the powder layer is increased, and cavities or unevenness of the powder layer defects are reduced.

The powder compaction assembly 100 of the present embodiment can improve compaction density and compaction uniformity of the powder layer, improve compaction quality of the powder layer, improve quality of print layer formed by printing the powder layer, and improve overall quality of printed parts printed by the powder layer.

Furthermore, the powder compaction assembly 100 can improve quality of the powder layer by co-operation of the powder compaction roller 20 and the scraper 30, so that movement speed of the powder laying mechanism 204 along the powder spreading direction Y1 does not need to be reduced, and efficiency of the powder spreading can be improved.

Furthermore, when the thickness h of the powder layer is changed, value of ΔH may also need to be adjusted. For example, when thickness h of the powder layer is reduced, value of ΔH is reduced accordingly. When thickness h of the powder layer is increased, value of ΔH is increased accordingly. In one embodiment, by rotating the rotary member 40 to drive the scraper 30 along the adjusting direction Y2, the value of ΔH can be adjusted simply, and meet laying requirements of the powder layers with different thicknesses.

In one embodiment, referring to FIG. 3, two mounting frames 10 are provided, the two mounting frames 10 are spaced apart along an axial direction of the powder compaction roller 20, two ends of the powder compaction roller 20 are rotatably connected to the two mounting frames 10 respectively. The two mounting frames 10 can support the powder pressing roller 20 stably, ensure reliability of the powder compaction roller 20 during powder pressing process.

The powder compaction assembly 100 further includes two bearings 53, the two bearings 53 are provided in each of the two mounting frames 10, and two ends of the powder compaction roller 20 are fitted in the two bearings 53. The first actuator 51 is provided on a side of one mounting frame 10 away from the other mounting frame 10.

In one embodiment, referring to FIG. 3, the first actuator 51 includes a output shaft. The powder compaction assembly 100 further includes a coupling block 54. The coupling block 54 is arranged between the first actuator 51 and the mounting frame 10. One end of the coupling block 54 is connected to the output shaft, and another end of the coupling block 54 defines a pinhole 55. One end of the powder compaction roller is provided with a pin block 56, the pin block 56 fits within the pinhole 55, and connects the powder compaction roller 20 to the coupling block 54.

In other embodiment, the powder press roller 20 may also be connected to the output shaft directly. For example, the powder press roller 20 is connected to the output shaft by a key connection, a screw connection.

In one embodiment, referring to FIG. 3, surfaces of the two mounting frames are opposite to each other, and are defines a first guide groove 11 and a second guide groove 11a. lengthwise direction of the first guide groove 11 is parallel to the adjusting direction Y2, lengthwise direction of the second guide groove 11a is parallel to the adjusting direction Y2. one end of the scraper 30 fit inside of the first guide groove 11 slidably, other end of the scraper 30 fit inside of the second guide groove 11a slidably. The guide groove 11 can limit movement of the scraper 30, and ensure the scraper 30 does not deviate from the adjusting direction Y2, thereby improve accuracy and precision of distance between the second tangent plane M2 and the molding surface 207.

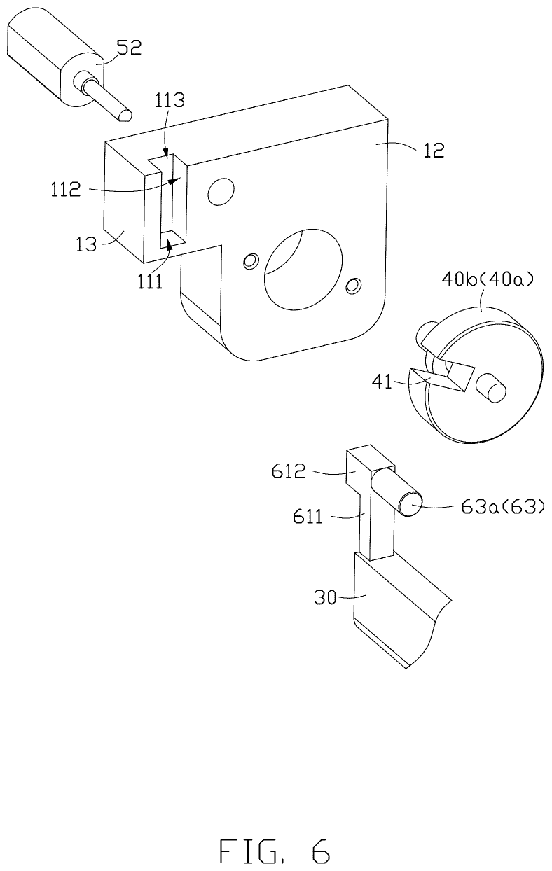

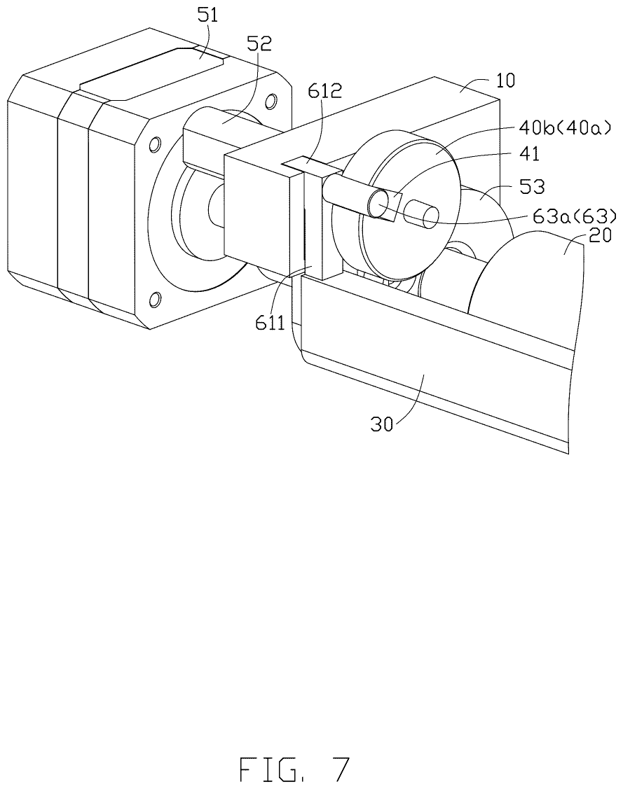

In one embodiment, referring to FIG. 6 and FIG. 7, the guide groove 11 defines a bottom surface 111 and a first opening 112. The first opening 112 is defined on a side of the mounting frame 10. A guide part 61 is provided at each ends of the scraper 30, the guide part 61 extends into the guide groove 11 from the first opening 112, and the guide part 61 can reach the bottom surface 111 to define a limiting position of the scraper 30.

When the rotary member 40 drive the scraper 30 move to close the molding surface 207 along the adjusting direction Y2, and the guiding part 61 rests against the bottom surface 111, the bottom surface 111 plays a limiting role on the guide part 61, and restrict the scraper 30 to move in a limiting position along the adjusting direction Y2, so as to avoid rotation of the rotary member 40 to drive the scraper 30 against and damage the molding surface 207, thus to ensure intactness of the molding surface 207 during adjustment process of the doctor blade 30.

In one embodiment, referring to FIG. 7, the guide part 61 includes a vertical segment 611 and a horizontal segment 612, the vertical segment 611 is connected to the scraper 30, the horizontal segment 612 is connected to one side of the vertical segment 611, and the horizontal segment 612 extends into the first guide groove 11 or the second guide groove 11a from the first opening 112. The horizontal segments 612 of the two guide parts 61 extends in opposite directions and extend into each of the first guide groove 11 and the second guide groove 11a.

The vertical segment 611 can extend size of the scraper 30 along the adjustment direction Y2 properly, so that the scraper 30 can fit with the rotary member 40 which is far away from the molding surface 207, and facilitate structural design of the powder compaction assembly 100.

In one embodiment, the vertical segment 611 may also be connected to the scraper 30 in a removable manner, so that an existing scraper may be utilized in processing the powder compaction assembly 100. The vertical section 611 may be connected to the scraper 30 by a removable connection such as a snap or a thread.

In one embodiment, referring to FIG. 6, the guide groove 11 defines a second opening 113, the second opening 113 is defined at top surface of the mounting frame 10, and the second opening 113 is communicated with the first opening 112. The horizontal segment 612 of the guide part 61 can be fitted into the guide groove 11 from the second opening 113 to facilitate assembly of the powder compaction assembly 100.

Furthermore, referring to FIG. 6, the mounting frame 10 includes a first portion 12 and a second portion 13, the first portion 12 connects to the second portion 13, and the second portion 13 and the first portion 12 are distributed along the powder spreading direction Y1. The powder compaction roller 20 is rotatably connected with the first portion 12 rotatably, the first guide groove 11 is defined at one second portion 13, and the second guide groove 11a is defined at other second portion 13.

Joint of the powder compaction roller 20 and the first portion 12 is between the guide groove 11 and the forming surface 207.

In one embodiment, the powder compaction assembly 100 includes one first portion 12 and one second portion 13. In other embodiment, the first portion 12 may be provided in two, and the two first portion s 12 are arranged on both sides of the second portion 13, and are distributed with the second portion 13 along the powder spreading direction Y1.

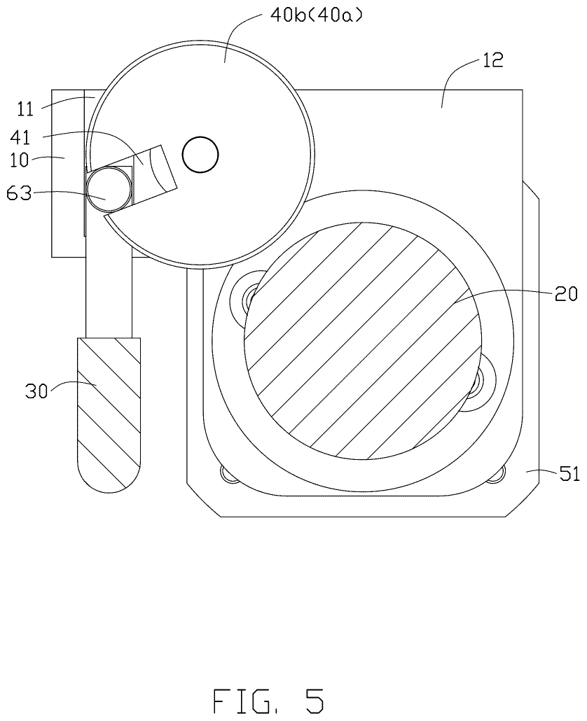

In one embodiment, referring to FIG. 4 and FIG. 5, the rotary member 40 is located between the two mounting frames 10, a sliding groove 41 is defined at the rotary member 40, lengthwise direction of the sliding groove 41 is perpendicular to rotation axis of the rotary member 40. The scraper 30 is provided with a moving arm 63, the moving arm 63 is arranged between the two mounting frames 10 and fit inside the sliding groove 41 glibly.

In this way, it is possible to improve space utilization rate between the two mounting frames 10, and reduce size of the powder compaction assembly 100 along length direction of the powder compaction roller 20, and facilitate miniaturization design.

When the rotary member 40 rotates around its rotation axis, the rotary member 40 can drive the sliding groove 41 to rotate around the rotation axis, and drive the moving arm 63 to rotate around the rotation axis. Since the moving arm 63 is limited by the scraper and the guide groove 11 at the same time, the moving arm 63 can only move along the adjustment direction Y2, and then drive the scraper 30 to move along the adjustment direction Y2.

In one embodiment, the moving arm 63 is connected to the guide part 61 on a side of the scraper 30 near the first actuator 51, and is fixed to the side of the vertical segment 611 of the guide part 61 away from the horizontal segment 612.

In one embodiment, the rotary member 40 includes a rotating plate 40a, the rotating plate 40a connects to the mounting frame 10 rotatably, rotation axis of the rotating plate 40a is parallel to the molding surface 207, the sliding groove 41 is defined at edge of the rotating plate 40a in the radial direction of the rotary plate 40a.

In other embodiment, a travel groove is defined at an inside edge of the rotating plate 40a, and length direction of the travel groove is perpendicular to rotation axis of the rotating plate 40a, and the moving arm 63 fits in the travel groove slidably.

Furthermore, the rotating plate 40a is formed as a circular plate 40b, rotation axis of the circular plate 40b passes through center of the circular plate 40b, and groove depth of the sliding groove 41 is not less than half of radius of the circular plate 40b.

When the circular plate 40b rotates, projection position and area of the circular plate 40b along length direction of the powder compaction roller 20 will not change, thus reduce possibility of interference between the rotation of the circular plate 40b and other structures.

Increasing groove depth of the sliding groove 41 can ensure that when the circular plate 40b rotates at a large angle, the moving arm 63 can still be located within the sliding groove 41, and reduces the possibility of the moving arm 63 fall off opening of the sliding groove 41 along edge of the circular plate 40b.

In other embodiment, the rotary member 40 can be formed as a rotary rod, one end of the rotary rod connect to the mounting frame 10 rotatably, and connect to output end of the second actuator 52, other end of the rotary rod defines a travel groove, length direction of the travel groove is parallel to length direction of the rotary rod. The moving arm 63 on the scraper 30 slidably fits into the travel groove.

In this way, it is also possible to drive the moving arm 63 to move when the rotary rod is rotating, and then drive the scraper 30 to move along the adjusting direction Y2.

Furthermore, the moving arm 63 includes a round rod 63a, the round rod 63a is tangent to two groove surfaces of the sliding groove 41, and the two groove surfaces are opposite to each other. When the moving arm 63 moves along the sliding groove 41, friction generated by the groove surface on the moving arm 63 is reduce, and improve smoothness of the rotary member 40 driving the scraper 30 along the adjustment direction Y2.

What is claimed is:

1. A powder compaction assembly, the powder compaction assembly is configured to compact powder on a molding surface, the powder compaction assembly comprising:
one or more mounting frame;
a powder compaction roller, the powder compaction roller is rotatably disposed in the mounting frame;
a scraper, the scraper is movably arranged on the mounting frame in an adjusting direction, the adjusting direction and the molding surface are perpendicular or intersecting, and the scraper is separable from the powder compaction roller;
a rotary member, the rotary member is rotatably connected to the mounting frame, and the rotary member is fitted with the scraper, the rotary member is configured to rotate relative to the mounting frame and drive the scraper to move along the adjusting direction, and adjust distance between the scraper and the molding surface in the adjusting direction.

2. The powder compaction assembly as claimed in claim 1, wherein the rotary member comprises a rotating plate, the rotating plate is rotatably connected to the mounting frame, a rotation axis of the rotating plate is parallel to the molding surface, a sliding groove is defined at an edge of the rotating plate in a radial direction of the rotary plate;
the scraper is provided with a moving arm, the moving arm is received in the sliding groove.

3. The powder compaction assembly as claimed in claim 2, wherein the moving arm comprises a round rod, outer surface of the round rod is tangent to two groove surfaces of the sliding groove.

4. The powder compaction assembly as claimed in claim 1, wherein the powder compaction assembly further comprises two mounting frames, the two mounting frames are spaced apart along an axial direction of the powder compaction roller, two ends of the powder compaction roller are rotatably connected to the two mounting frames respectively.

5. The powder compaction assembly as claimed in claim 4, wherein surfaces of the two mounting frames opposite to each other are defines a first guide groove and a second guide groove, a lengthwise direction of the first guide groove is parallel to the adjusting direction, and a lengthwise direction of the second guide groove is parallel to the adjusting direction, and one end of the scraper fits inside of the first guide groove slidably, another end of the scraper slidably fits inside of the second guide groove.

6. The powder compaction assembly as claimed in claim 5, wherein the guide groove defines a bottom surface and a first opening; the first opening is opened on a side of the mounting frame; a guide part is provided at each ends of the scraper, the guide part extends into the guide groove from the first opening, and the guide parts can reach the bottom surface to define a limiting position of the scraper.

7. The powder compaction assembly as claimed in claim 6, wherein the guide part comprises a vertical segment and a horizontal segment, the vertical segment is connected to the scraper, the horizontal segment is connected to one side of the vertical segment, and the horizontal segment extends into the guide groove from the first opening.

8. The powder compaction assembly as claimed in claim 5, wherein each of the two mounting frames further comprises a first portion and a second portion, the first portion is connected to the second portion, the powder compaction roller is rotatably connected with the first portion, the first guide groove is defined at the second portion of one of the two mounting frames, and the second guide groove is defined at the second portion of another of the two mounting frames.

9. The powder compaction assembly as claimed in claim 6, where in the rotary member comprises a rotating plate, the rotating plate is rotatably connected to the mounting frame, a rotation axis of the rotating plate is parallel to the molding surface, a sliding groove is defined at an edge of the rotating plate in a radial direction of the rotary plate;
the scraper is provided with a moving arm, the moving arm is received in the sliding groove, and the moving arm is connected to one guide part.

10. The powder compaction assembly as claimed in claim 4, wherein the rotary member is arranged between the two mounting frames, the rotary member defines a sliding groove, a lengthwise direction of the sliding groove is perpendicular to a rotation axis of the rotary member,
the scraper is provided with a moving arm, the moving arm is located between the two mounting frames and received the sliding groove.

11. A powder laying mechanism, comprising:
a powder bin, the powder bin is configured to storage and export powder;
a powder spreading roller, the powder spreading roller is arranged in the powder bin;
a powder compaction assembly as claimed in claim 1, the mounting frame of the powder compaction assembly is connected to the powder bin, and the powder compaction assembly is configured to compact powder on the molding surface.

12. The powder compaction assembly as claimed in claim 11, wherein the rotary member comprises a rotating plate, the rotating plate is rotatably connected to the mounting frame, a rotation axis of the rotating plate is parallel to the molding surface, a sliding groove is defined at an edge of the rotating plate in a radial direction of the rotary plate;
the scraper is provided with a moving arm, the moving arm is received in the sliding groove.

13. The powder compaction assembly as claimed in claim 12, wherein the moving arm comprises a round rod, outer surface of the round rod is tangent to two groove surfaces of the sliding groove.

14. The powder compaction assembly as claimed in claim 11, wherein the powder compaction assembly further comprises two mounting frames, the two mounting frames are spaced apart along an axial direction of the powder compaction roller, two ends of the powder compaction roller are rotatably connected to the two mounting frames respectively.

15. The powder compaction assembly as claimed in claim 14, wherein surfaces of the two mounting frames opposite to each other are each defines a first guide groove and a second guide groove, lengthwise direction of the first guide groove is parallel to the adjusting direction, and lengthwise direction of the second guide groove is parallel to the adjusting direction, and one end of the scraper fit inside of the first guide groove slidably, another end of the scraper fit inside of the second guide groove slidably.

16. The powder compaction assembly as claimed in claim 15, wherein the guide groove defines a bottom surface and a first opening; the first opening is opened on a side of the mounting frame; a guide part is provided at each ends of the scraper, the guide part extends into the guide groove from the first opening, and the guide part can reach the bottom surface to define a limiting position of the scraper.

17. The powder compaction assembly as claimed in claim 16, wherein the guide part comprises a vertical segment and a horizontal segment, the vertical segment is connected to the scraper, the horizontal segment is connected to one side of the vertical segment, and the horizontal segment extends into the guide groove from the first opening.

18. The powder compaction assembly as claimed in claim 14, wherein the rotary member is arranged between the two mounting frames, the rotary member defines a sliding groove, a lengthwise direction of the sliding groove is perpendicular to a rotation axis of the rotary member,
the scraper is provided with a moving arm, the moving arm is located between the two mounting frames and received the sliding groove.

19. A additive manufacturing equipment, comprising:
a print substrate, the print substrate defines a molding surface;
a powder laying mechanism as claimed in claim 11, the powder laying mechanism is configured to lay down powder to the print substrate;
a drive element, the drive element is configured to drive the powder laying mechanism move relative to the print substrate along powder spreading direction.
